(19) United States
(12) Patent Application Publication
(10) Pub. No.: US 2015/0227319 A1
(43) Pub. Date: Aug. 13, 2015

(54) NON-VOLATILE STORAGE DEVICE IMAGE CREATION

(71) Applicant: Lenovo (Singapore) Pte. Ltd., Singapore (SG)

(72) Inventors: Jun Li, Cary, NC (US); Scott Wantao Li, Cary, NC (US); Bruce Douglas Gress, Raleigh, NC (US); Fred F. Holt, JR., Cary, NC (US); Humberto Salvador Argaluza, Cary, NC (US)

(73) Assignee: Lenovo (Singapore) Pte. Ltd., Singapore (SG)

(21) Appl. No.: 14/178,364

(22) Filed: Feb. 12, 2014

(51) Int. Cl. G06F 3/06

(52) U.S. Cl. CPC G06F 3/0619; G06F 3/0647; G06F 3/0688

(57) ABSTRACT

An embodiment provides a method, including: integrating a non-volatile memory into a first information handling device; installing an image on the non-volatile memory; storing a recovery version of the installed image in another memory location of another device; and thereafter providing the recovery version to a non-volatile memory of a second information handling device. Other aspects are described and claimed.

### BACKGROUND

Information handling devices (“devices”), for example laptop computers, tablets, smart phones, e-readers, etc., utilize an operating system. During manufacture of such devices, recovery mechanisms are provided such that an operating system may be recovered.

Commonly in devices a recovery image is provided with the integral non-volatile storage that holds the image, e.g., hard disk drive (HDD) or other solid state memory. With the advent and increasing commonality of inclusion of removable non-volatile storage devices, e.g., SD cards included with tablet devices, operating system providers, e.g., Microsoft Corporation, have permitted inclusion of a recovery image on the removable non-volatile storage, e.g., included on the SD card for a tablet device.

### BRIEF SUMMARY

In summary, one aspect provides an apparatus, comprising: a processor; an integral non-volatile memory operatively coupled to the processor; the integral non-volatile memory having an image with a first creation date associated therewith; and a non-volatile memory card, said non-volatile memory card comprising an image with a second creation date associated therewith; wherein said first creation date is later in time than the second creation date.

Another aspect provides an apparatus, comprising: a processor; an integral non-volatile memory operatively coupled to the processor; the integral non-volatile memory having an image produced via a first process; and a non-volatile memory card, said non-volatile memory card comprising a recovery image produced via a separate duplication process; wherein said separate duplication process comprises a card duplication process.

Another aspect provides a method, comprising: integrating a non-volatile memory into a first information handling device; installing an image on said non-volatile memory; storing a recovery version of the installed image in another memory location of another device; and thereafter providing the recovery version to a non-volatile memory of a second information handling device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of an information handling device.

FIG. 3 illustrates an example method of non-volatile storage device recovery image creation and duplication.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As described herein, operating system providers have permitted inclusion of a recovery image on the removable non-volatile storage, e.g., included on the SD card for a tablet device. For example, starting from MICROSOFT WINDOWS operating system version 8.1, Microsoft Corporation permits original equipment manufacturers to utilize an SD card as a recovery media for systems that have less than 64G EMMC (embedded multi media card) memories. This feature in WINDOWS operating system recovery solutions is helpful in that it permits use of new memories to be considered valid storage locations for recovery images and has assisted in that a duplicated SD card preload and recovery method allows for significantly reduced manufacturing time. However, even utilizing this approach, each preload system has to go through download, audit, capture of the recovery image (lasting approximately 40 minutes) and copying of the captured image to the SD card for that system (lasting approximately 20 min).

Accordingly, an embodiment separates the preload process from the SD card creation to save manufacturing time. In this process, the captured recovery image is generalized and duplicated using a card duplication process. Thus, only one preload system needs an SD card for creation of the recovery image, and only this system needs to go through the download, audit, and capture procedure. Once a recovery image is prepared, a copy of the captured image for recovery is made for that system (to the SD card) and/or a copy of the recovery image is stored in another memory such as a remote storage location. Thus, a “recovery” SD card and/or a copy of the recovery SD card (e.g., saved to remote storage) is/are available for use in a card duplication process.

Other systems then only need to go through a significantly shortened preload process (e.g., apply the captured image on the SD card for that particular system and then a mini-audit boot). After the first recovery SD card creation through preload process, the rest of SD cards for the other systems can be produced by using an SD card duplicator, offering significant time savings.

The illustrated example embodiments will be best understood by reference to the figures. The following description is intended only by way of example, and simply illustrates certain example embodiments.

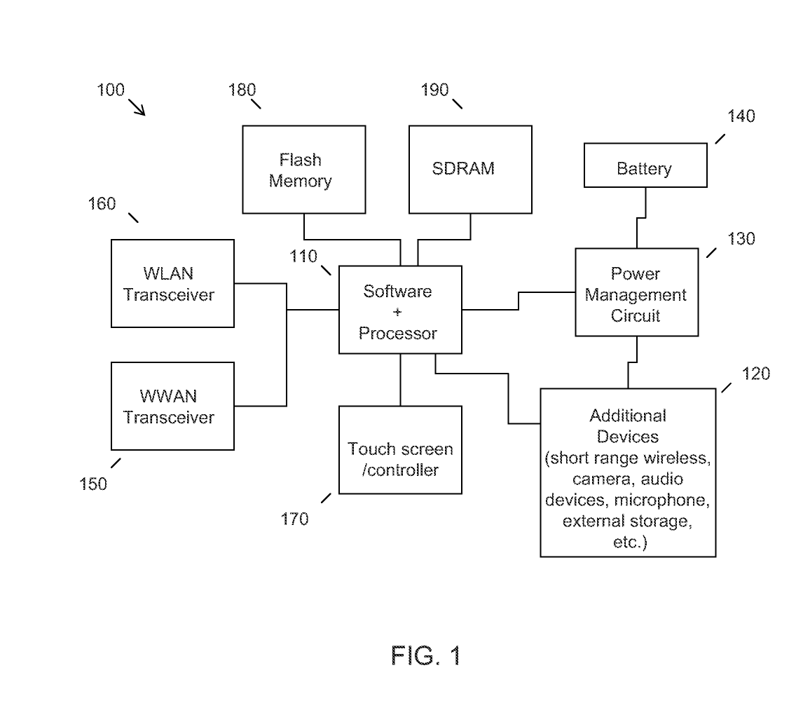

While various other circuits, circuitry or components may be utilized in information handling devices, with regard to smart phone and/or tablet circuitry 100, an example illustrated in FIG. 1 includes a system on a chip or circuit design found for example in tablet or other mobile computing platforms. Software and processor(s) are combined in a single chip or circuit 110. Processors comprise internal arithmetic units, registers, cache memory, busses, I/O ports, etc., as is well known in the art. Internal busses and the like depend on different vendors, but essentially all the peripheral devices (120) may attach to a single chip or circuit 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) or circuit(s) 130, e.g., a battery management unit, BMU, which manage power as supplied, for example, via a rechargeable battery 140, which may be recharged by a connection to a power source (not shown). In at least one design, a single chip or circuit, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additional devices 120 may be included, for example external storage. Commonly, system 100 will include a touch screen 170 for data input and display/rendering. System 100 also typically includes various memory devices, for example flash memory 180 and SDRAM 190.

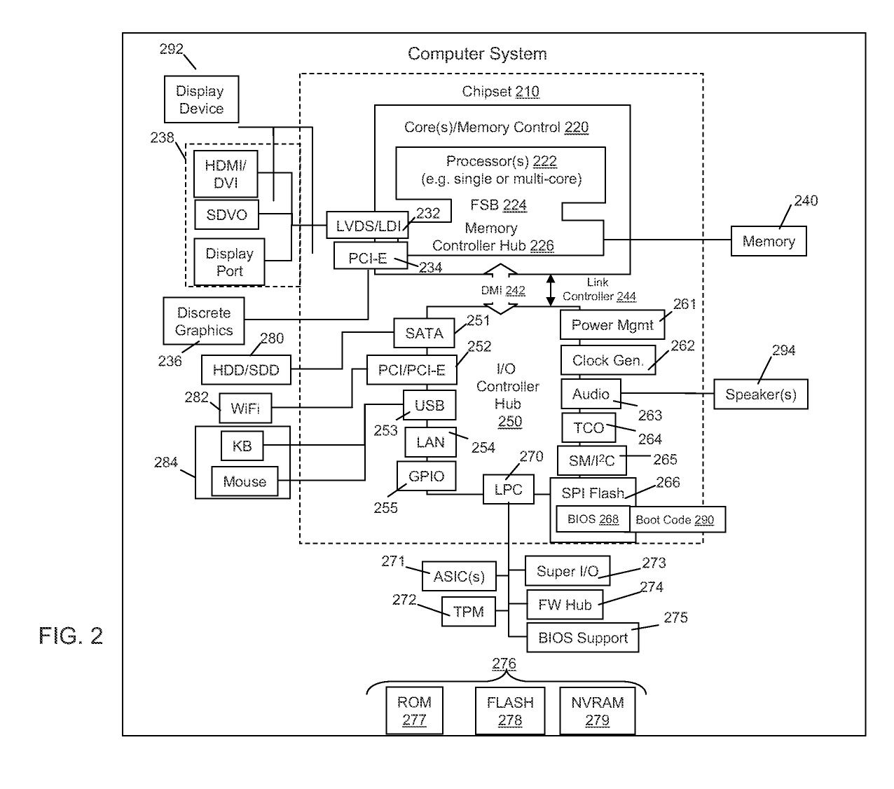

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices that utilize non-volatile memory cards, e.g., SD cards (noting this is a non-limiting example) in which a recovery image may be stored.

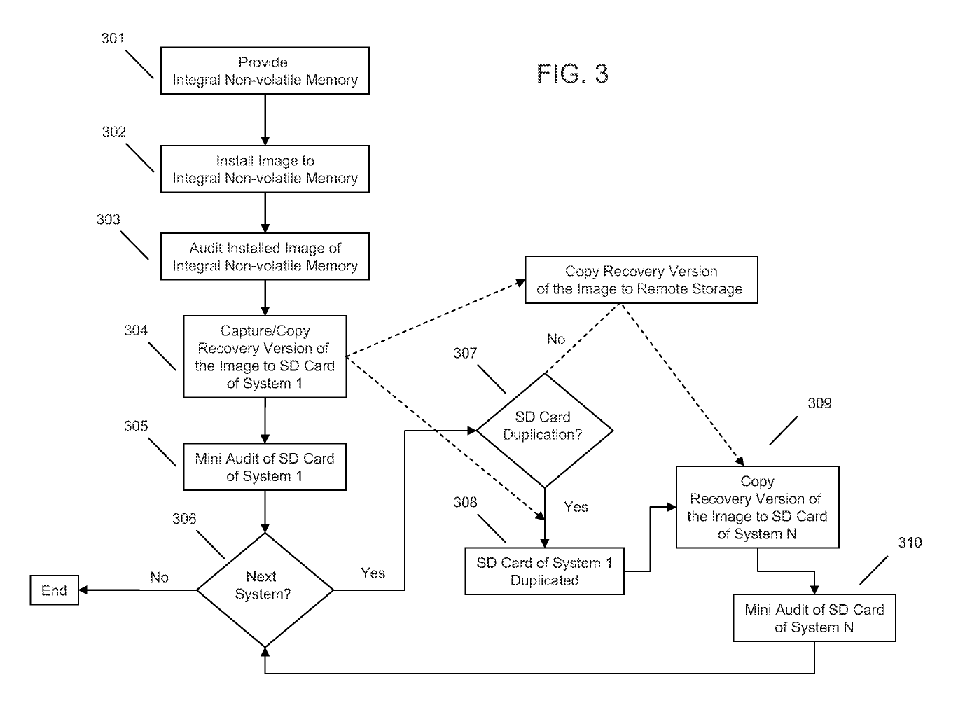

Referring to FIG. 3, in an embodiment an integral non-volatile memory is provided at 301, e.g., an HDD or solid state memory device of an apparatus/information handling device such as a laptop computing device, a tablet computing device, etc. An image including an operating system is then installed on the integral non-volatile memory at 302. In this process, for example, an operating system is installed and specialized to the particular system type, which may be considered as an auditing of the image, e.g., as illustrated at 303.

A copy of the image may then be captured to prepare a recovery version of the image at 304. For example, a recovery version may be stored to the SD card of the system in question, e.g., as illustrated at 304 and/or a copy of the recovery version of the image may be stored elsewhere, e.g., a remote storage device, such as illustrated in FIG. 3. This recovery version of the image may be generalized (not explicitly illustrated).

Thereafter, a mini audit of the SD card contents, i.e., the recovery version of the image, may be performed at 305, for example because the copy of the image used for recovery has been generalized. This amounts to a full preparation of the first system and does not account for the significant time savings afforded by embodiments described herein.

However, having a copy of the recovery image available, e.g., as prepared at 304 for example, a process may thereafter (i.e., for second and subsequent systems) be applied that materially or significantly decreases manufacturing time, as follows.

According to an embodiment, in the next system, e.g., as determined at 306 of FIG. 3, a recovery image may be provided via determining SD card duplication is appropriate, e.g., as illustrated at 307 and thereafter duplicating the SD card prepared for the first system, as illustrated at 308. Alternatively, a copying of the recovery version of the image stored in remote storage, as illustrated in FIG. 3, may be used to provide a recovery version of the image to the next system SD card. Thus, a recovery image may be provided to the next system's non-volatile memory card by copying/duplicating the first system's SD card contents, as illustrated at 309. It is worth noting that the dashed lines in FIG. 3 are included only for ease of illustration.

As may be appreciated, the auditing step illustrated at 303 need not be replicated or re-performed for each system considering that, for like systems, the recovery image may be duplicated (again either via SD duplication process or via copying from remote storage). The omission of the auditing step at 303 will, depending on the number of systems handled, significantly decrease manufacturing time by essentially limiting auditing to a mini-audit of the generalized, duplicated recovery image, as illustrated at 310.

It may be noticed that in time, a new system's integrated storage device may have a later date than that of the duplicate image provided in the non-volatile memory card. In other words, the non-volatile memory card (e.g., SD card) will have been duplicated and thus retain a date associated with the first system (from which it descends). In contrast the new systems' integrated non-volatile memory will have the image installed anew, leading to a create date associated with this image that is later in time. Such creation date information may be stored, e.g., in a log file, in a pre-load log, etc.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable storage medium(s) may be utilized. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An apparatus, comprising:
a processor;
an integral non-volatile memory operatively coupled to the processor;
the integral non-volatile memory having an image with a first creation date associated therewith; and
a non-volatile memory card, said non-volatile memory card comprising an image with a second creation date associated therewith;
wherein said first creation date is later in time than the second creation date.

2. The apparatus of claim 1, wherein the non-volatile memory card is a removable card.

3. The apparatus of claim 1, wherein the image with a first creation date and the image with the second creation date are substantially identical.

4. The apparatus of claim 1, wherein the image having the second creation date comprises a generalized recovery image of the image having the first creation date.

5. The apparatus of claim 1, wherein the second creation date is associated with a non-volatile memory card duplication process.

6. The apparatus of claim 1, wherein the second creation date is stored in a log file.

7. An apparatus, comprising:
a processor;
an integral non-volatile memory operatively coupled to the processor;
the integral non-volatile memory having an image produced via a first process; and
a non-volatile memory card, said non-volatile memory card comprising a recovery image produced via a separate duplication process;
wherein said separate duplication process comprises a card duplication process.

8. The apparatus of claim 7, wherein said card duplication process is seeded using a copy of the image stored outside said apparatus.

9. The apparatus of claim 8, wherein said recovery image is a descendant of a generalized version of said image.

10. A method, comprising:
integrating a non-volatile memory into a first information handling device;
installing an image on said non-volatile memory;
storing a recovery version of the installed image in another memory location of another device; and
thereafter providing the recovery version to a non-volatile memory of a second information handling device.

11. The method of claim 10, wherein the installing comprises auditing the image.

12. The method of claim 10, wherein the storing a recovery version of the installed image comprises storing a generalized version.

13. The method of claim 10, wherein the storing a recovery version of the installed image comprises storing a recovery version in a remote memory location.

14. The method of claim 12, wherein the providing the recover version to a non-volatile memory card comprises duplicating the recovery version in a card duplication process.

15. The method of claim 14, further comprising operatively coupling a duplicated card having the recovery version in another information handling device having a copy of image on an integrated non-volatile memory.

16. The method of claim 15, further comprising completing an audit of the duplicated card while coupled to the another information handing device.

17. The method of claim 15, wherein said copy of image on an integrated non-volatile memory and said recovery version of said duplicate card have different creation dates associated therewith.

18. The method of claim 17, wherein said recovery version has an earlier creation date than said copy of image on an integrated non-volatile memory.
